(19) United States
(12) Patent Application Publication
(10) Pub. No.: US 2005/0050253 A1
(43) Pub. Date: Mar. 3, 2005

(54) Programmable bus arbitration

(76) Inventor: Srikanth Rengarajan, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/648,114

(22) Filed: Aug. 25, 2003

(51) Int. Cl. G06F 13/00; G06F 13/36; G06F 13/362

(52) U.S. Cl. 710/113; 710/110

(57) ABSTRACT

A bus arbitration scheme may include a bus arbiter that grants bus requests based on a combination of both hierarchical ranking and age, where age is an indication of a time interval since a bus request was made but not granted. The hierarchical rankings and the manner in which rankings and age are combined may be programmable. These techniques may also be combined with other arbitration techniques.

### BACKGROUND

In computer systems, devices may communicate with each other over one or more shared buses. To avoid conflicts that would occur if more than one device attempted to communicate over a bus at the same time, various arbitration schemes may be generally used to assign use of the bus to only one device at a time. In the round-robin technique, each device in turn is given the chance to use the bus in a continuing, rotating fashion. Over time, every device may therefore have equal access to the bus, but at any given time, any device might have to wait for the bus until that device's turn comes. This is a disadvantage for a device that has a need to access the bus quickly, if another device that could have waited is granted access first. Even if only one device is requesting the bus, that device may have to wait until its turn. The round-robin technique may not be suited for time-critical data transfers in which data may be lost if it is not transferred within a particular time frame.

In the hierarchical technique, the devices are assigned rankings. If two or more devices are requesting the bus at the same time, the higher-ranking device is granted access. While this may improve performance for time-critical devices, it may also result in a condition called starvation, in which a lower-ranking device is repeatedly denied access to the bus because higher-ranking devices consume all the available bus time.

The shortcomings of these techniques are further aggravated by the fact that the optimum priorities among the devices, and therefore the relative advantages/disadvantages of a particular technique, may change within a system when different applications are run, and may even change dynamically as the same applications run.

### BRIEF DESCRIPTION OF THE DRAWINGS

The invention may be understood by referring to the following description and accompanying drawings that are used to illustrate embodiments of the invention. In the drawings:

FIG. 1 shows a block diagram of a portion of a system, according to an embodiment of the invention.

FIG. 2 shows a block diagram of some of the components of an arbiter, according to an embodiment of the invention.

FIGS. 3A and 3B show a flow chart of a method of operation of an arbiter, according to an embodiment of the invention.

FIG. 4 shows a system containing an arbiter, according to an embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques may not be shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Some embodiments of the invention may use a combination of some or all of ranking, age since the bus was first requested, retry status, order of connection, etc., to grant bus access to one of the requesters. Some of the techniques used may be programmable on-the-fly as the system operates.

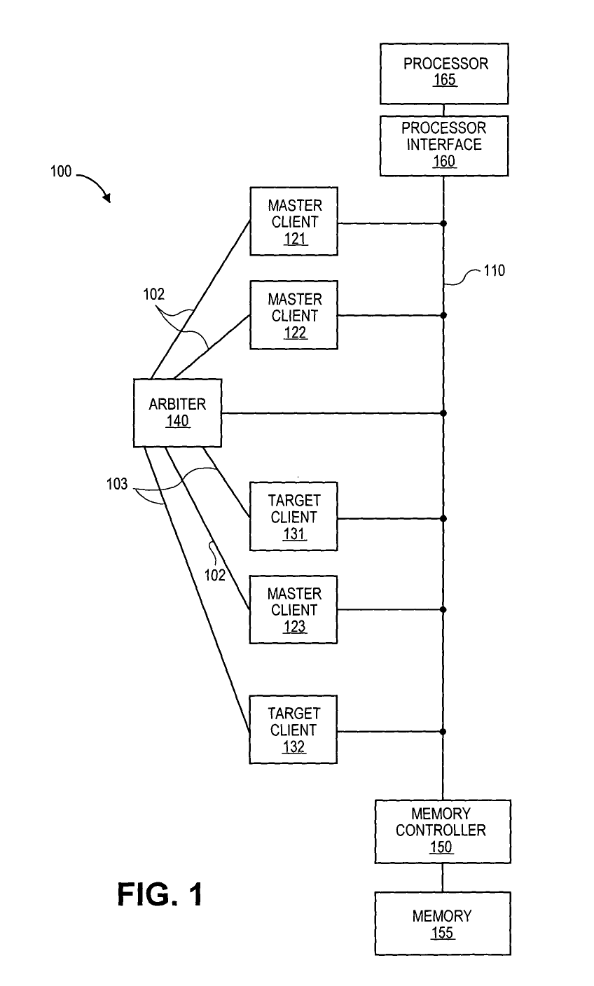

FIG. 1 shows a block diagram of a portion of a system 100, according to an embodiment of the invention. Bus 110 may be used to transfer data between various clients 121-123, 131-132 that are coupled to the bus 110. Arbiter 140 may arbitrate between bus requests from multiple clients to determine which client is to be granted the bus next, the arbitration to be performed according to various criteria. Some of the criteria may be programmable in arbiter 140. Once a bus request is made by a client, the request may be referred to as a pending request and/or as an ungranted request until the request is granted by the arbiter 140.

A client may be a physical device and/or a circuit that transfers data over the bus 110, where data may include a command, status, information, etc. Examples of clients may include, but are not limited to, such things as a disk controller, a bus bridge, a graphics accelerator, a memory, etc. Within the context of this description, signals that are only used to facilitate the transfer (e.g., bus clock, device address, data enable, etc.) are not considered data, even though they may be necessary for the transfer of data. Transferring data may include transmitting data, receiving data, or both. FIG. 1 shows both master clients 121-123 and target clients 131-132, but other embodiments may have only one or the other, and/or may have other types of clients. A master client is a client that may command another client to transmit data over the bus, while a target client may only respond to such commands from a master client by providing the requested data. In some embodiments, a particular client may act as a master client for one data transfer sequence and a target client for another data transfer sequence. For the purposes of this disclosure, a data transfer sequence may include a command and any response(s) to that command, even if the responses must arbitrate for the bus separately from the command, while a bus transaction may include only a transfer of data resulting from a given arbitration.

In the illustrated embodiment a single bus 110 is shown connecting processor interface 160, memory controller 150, arbiter 140, and clients 121-123, 131-132, but in other embodiments these connections may be made through multiple buses and/or through other circuitry not shown. In one embodiment the bus 110 is a split-transaction bus, but other types of buses may also be used. A split-transaction bus may comprise a bus using split-transaction data transfer protocol, in which the target client arbitrates for, and obtains control of, the bus before sending the response requested by the master client, and in which other bus transactions involving other clients may take place over the bus between the command from the master client and the response from the target client. Thus a single data transfer sequence may be split into at least two separate bus transactions.

Arbiter 140 may be used to allocate control of the bus to various clients that request use of the bus to perform bus transactions. Request channels 102, 103 are shown coupling each client to the arbiter 140, where a request channel may convey a bus request from a client to the arbiter, and may also convey a grant of the bus from the arbiter to the requesting client, although the scope of the present invention is not limited in the respect. Bus requests and bus grants may be handled in various ways. In the illustrated embodiment, a separate request channel 102 is shown from each master client 121-123 to the arbiter 140, while a separate request channel 103 is shown from each target client 131, 132 to the arbiter 140. Other embodiments may use other techniques to convey bus requests from clients to the arbiter. For example: 1) all request channels may be identical, regardless of the nature of the client, 2) a common bus may be used to convey bus requests from multiple clients and convey bus grants to multiple clients, 3) the request channels may be part of bus 110, 4) the requests and grants may be handled through different techniques, 5) any combination of these techniques, 6) etc. Various techniques for conveying bus requests and bus grants between clients and an arbiter are known and are not discussed in detail herein to avoid obscuring an understanding of the various embodiments of the invention.

In one embodiment, arbiter 140 may be coupled to bus 110 so that portions of arbiter 140 may be programmed by processor 165, which may be coupled to arbiter 140 through processor interface 160 and bus 110. Processor interface 160 may, in turn, be comprised of any feasible combination of circuitry, buses, bridges and other components. Bus 110 may also be coupled to memory 155 through memory controller 150. Memory controller 150 may also be comprised of any feasible combination of circuitry, buses, bridges and other components. Memory 155 may utilize any feasible volatile or non-volatile technology that is currently existing or yet to be developed, for example, static random access memory (RAM), dynamic RAM, flash, magnetic, etc. In some embodiments, one or both of processor 165 and memory 155 may be clients whose bus requests are arbitrated by arbiter 140.

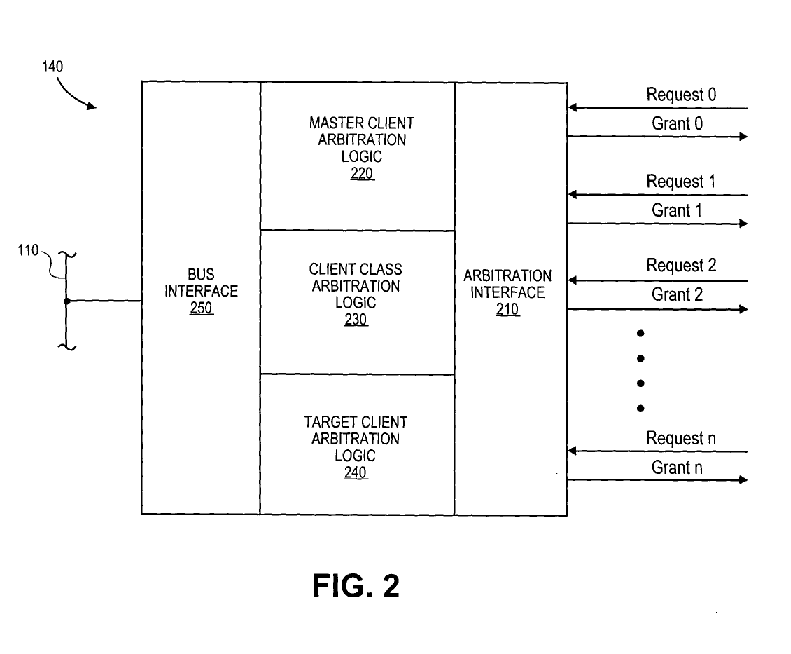

FIG. 2 shows a block diagram of some of the components of arbiter 140, according to one embodiment of the invention. In the embodiment of FIG. 2, arbiter 140 includes an arbitration interface 210, master client arbitration logic 220 to arbitrate among requesting master clients, target client arbitration logic 240 to arbitrate among requesting target clients, and client class arbitration logic 230 to determine which of the arbitration logics 220, 240, will be used in the current arbitration. Other embodiments may have a different configuration (e.g., classes of clients other than master/client, a single class of clients, a single integrated arbitration logic for any and/or all classes of clients, etc.) The embodiment of FIG. 2 shows a separate request line for each client (Request 0-n), over which the individual clients may send a bus request to arbiter 140, and a separate grant line for each client (Grant 0-n), over which arbiter 140 may send a grant signal to the selected client, but other embodiments may use other techniques to communicate bus requests and bus grants to/from arbiter 140 (e.g., a request bus, a grant bus, etc.). In some embodiments, each Request/Grant pair in FIG. 2 corresponds to one of the request channels 102, 103 in FIG. 1. In one embodiment arbiter 140 is a centralized arbiter, but other embodiments may use a distributed arbiter.

In the illustrated embodiment, master client arbitration logic 220 may perform arbitration for requests received from master clients, while target client arbitration logic 240 may perform arbitration for requests received from target clients. Client class arbitration logic 230 may determine which of arbitration logics 220, 240 will be able to perform arbitration at the present time (e.g., whether only master client requests or only target client requests will be considered during the current arbitration). In a particular embodiment, arbitration logics 220, 230, 240 may be standardized for the arbitration algorithms used, while arbitration interface 210 and/or bus interface 250 may be customized for the type of bus being used, thus permitting a single arbitration logic design to be easily adapted for multiple types of buses. Each of arbitration logics 220, 230, 240 may be implemented in various ways, such as discrete logic, one or more state machines, firmware, etc. Any or all of arbitration logics 220, 230, 240 and interfaces 210, 250 may be scalable to accommodate systems of various sizes and capacities.

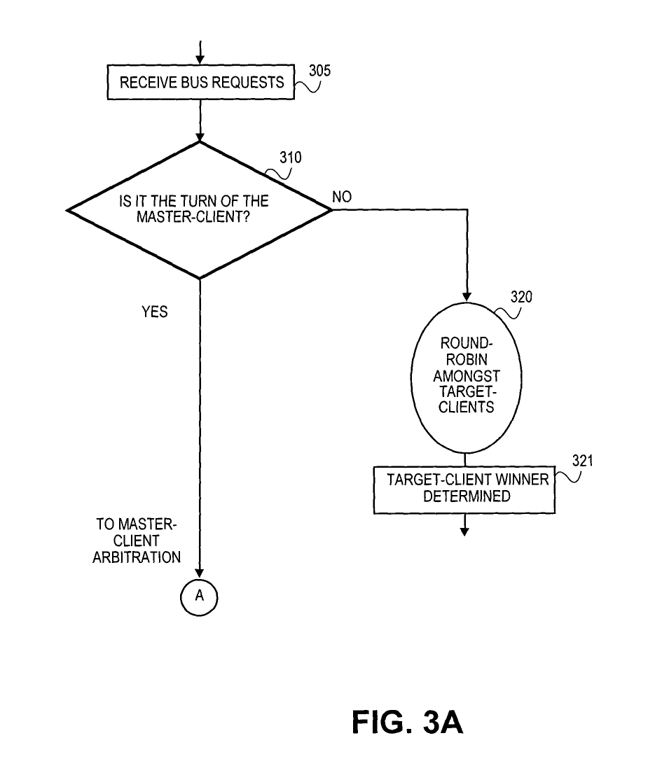

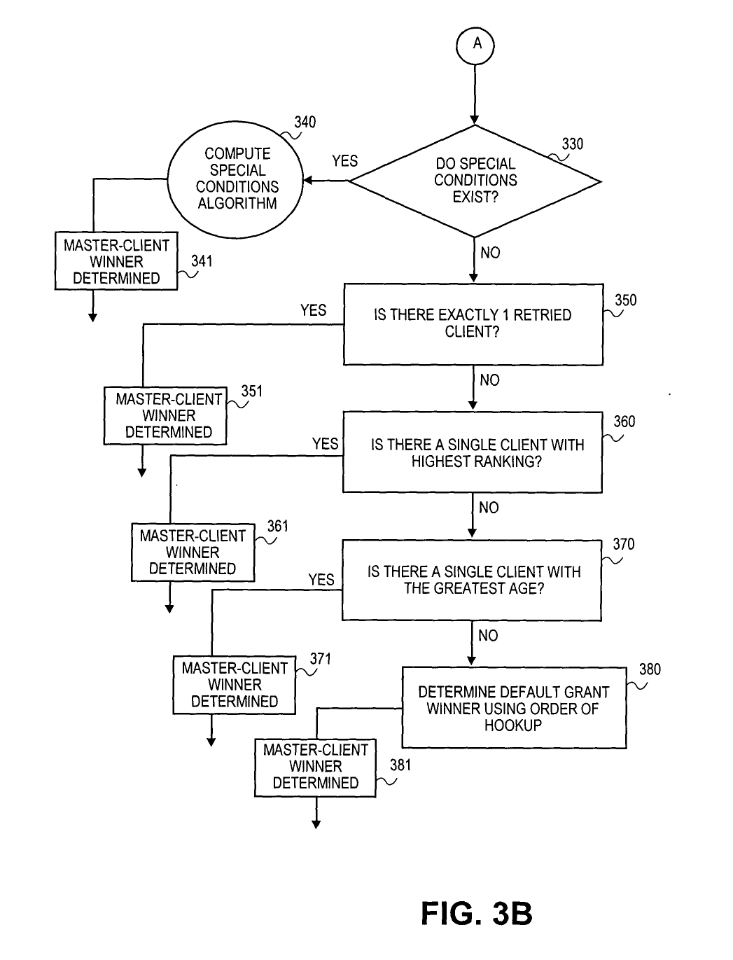

FIGS. 3A and 3B show a flow chart of a method of operation of an arbiter, according to one embodiment of the invention. Although the illustrated embodiment shows a particular combination of operations, other embodiments may contain a subset of these operations and/or additional operations not shown. In FIG. 3A, the process begins at 305 when one or more bus requests are received by an arbiter from one or more clients. Decision block 310 assumes that the arbiter alternates between handling bus requests from master clients and handling bus requests from target clients, although other techniques may be used. If both master and target clients are requesting the bus, processing may move to 320 if it is the turn of the target clients, and processing may move to ‘A’ (continued in FIG. 3B) if it is the turn of the master clients. If the pending requests are all from target clients, processing may default to 320, while if the pending requests are all from master clients, processing may default to ‘A’. Any bus request which has been made but not granted is considered a pending and/or an ungranted bus request until it is finally granted or until the bus request is cancelled.

If processing moves to 320, round-robin arbitration may be used. If multiple target clients are requesting the bus, at 321 the next target client in the round-robin process that is requesting the bus is selected as the ‘winner’, i.e., the target client that is granted access to the bus. If only one target client is requesting the bus, then that target client may be granted the bus. The process of actually granting the bus (i.e., informing the requesting client that it may now use the bus) is not shown, but may be assumed to follow from each of blocks 321 (FIG. 3A) and blocks 341, 351, 361, 371, and 381 (FIG. 3B).

If all requesting clients are master clients, or if some of the requesting clients are master clients and it is the master clients' turn at decision block 310, processing may continue at ‘A’ in FIG. 3B. At 330 it is determined if special conditions exist with regard to arbitration among master clients. If so, a special conditions algorithm may be executed at 340 to determine the master client winner at 341. Special conditions may include one or more of, but are not limited to, the following:

1) Bus lock—some bus protocols, such as the PCI-X bus protocol, allow a master client to take exclusive control of the bus until the lock condition is released. Under this condition, any competing clients may be denied access to the bus until the lock condition is released.

2) Sleep entry—during various types of sleep or standby modes, access to the bus may be restricted to some or all requesting clients. Such restricted access may take various forms, depending on the bus and the specific requirements of the system and the sleep protocols.

3) Lock-Out—To improve bus performance when retries are used, if a first master client tries to access a target that has a pending RETRY to a second master client, the first master client may be locked-out of the bus as long as the RETRY transaction is pending.

If no special conditions exist at 330, it may next be determined at 350 if any of the pending bus requests are retry requests. If only one of the pending requests is a retry request, that request may be determined the winner at 351. If there are no pending retry requests, processing may move to 360 to further consider all the pending requests from master clients. If multiple pending requests are retry requests, processing may move to 360 to further consider only those retry requests.

At 360 it is determined which of the pending requests being considered have the highest ranking in a hierarchical priority structure that assigns relative ranking to the various clients. If only one pending request has the highest ranking, that request may be determined the winner at 361, and the bus may be granted to the associated client. However, if multiple pending requests have the highest ranking, processing may move to 370 to further consider only those requests with the highest ranking. This situation may occur if the ranking values represent ‘levels’ of rank, and multiple clients (or their associated requests) may occupy the same level in the hierarchy.

At 370 it is determined which of the pending requests being considered have the greatest age. Age may be determined in various ways. For example, in one embodiment age may be measured as an indication of the number of clock cycles that have passed since the initial request was originally received, which may correspond to elapsed time. In another embodiment, age may be measured as the number of bus requests that have been granted to other clients since the request was initially received. In still another embodiment, age may be measured as the number of retries that have been made by the client since the initial request was received. Various other measures of age may also be used. If a single request is determined to have the greatest age, the associated client may be determined the winner at 371. If multiple requests are determined to have the same greatest age, processing may pass to 380 to further consider only those requests with the greatest age.

At 380, if there are still multiple requests being considered, a final arbitration made be made based on order of hook-up. Order of hook-up may be defined in various ways. For example, in one embodiment order of hook-up may be defined by relative bus addresses that are assigned at the time each client device is physically connected to the bus, by physical addresses that are hard-wired into the devices, by the physical location of the client devices on the bus, etc. Since order of hook-up, however defined, results in a strict hierarchy of clients, a single winner should be determined at this stage, and a single winner determined at 381.

When a single winner is determined at any feasible portion of the process of the flow chart of FIGS. 3A-3B, execution may exit the flow chart, and subsequently begin again at 305 for another arbitration.

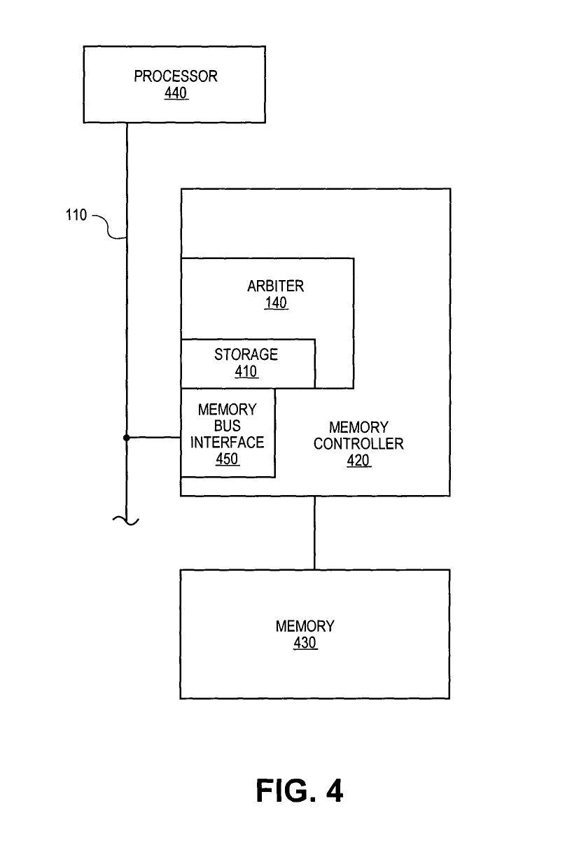

FIG. 4 shows a system containing an arbiter, according to one embodiment of the invention. In the illustrated embodiment, storage structure 410 provides a storage area in which the programmable parameters of arbiter 140 may be placed for operation. In one embodiment, storage structure 410 may include registers, but other forms of storage may also be used (e.g., individual flip-flops, volatile memory, non-volatile memory, etc.) For programmability, a bus interface may be necessary to transfer data into storage structure 410 and/or to read status information out of storage structure 410. In one embodiment the arbiter 140 may be placed into a memory controller 420, which is used to interface memory 430 to other devices in the system such as, for example, processor 440. The memory bus interface 450 may then be used to receive programming data for the arbiter 140 over bus 110 and place such data into storage structure 410. Similarly, memory bus interface 450 may be used to read out status information from storage structure 410 and place such status information on the bus 110 for receipt by other devices such as, for example, processor 440. Using a single bus interface 450 for both memory and arbiter operations may reduce overall complexity, design costs, and manufacturing costs.

In another embodiment, arbiter 140 may have its own dedicated bus interface 250 as shown in FIG. 2 and be a separately addressable device on but 110. In still another embodiment, arbiter 140 may be located in a bus device other than memory controller 420, and may share that other device's bus interface.

The foregoing description is intended to be illustrative and not limiting. Variations will occur to those of skill in the art. Those variations are intended to be included in the various embodiments of the invention, which are limited only by the spirit and scope of the appended claims.

1. An apparatus, comprising:
a bus to facilitate data transfers between clients; and
an arbiter coupled to the bus to grant bus access to one of the clients at a time based on a programmable priority assigned to at least some of the clients and on an age of an ungranted bus request.

2. The apparatus of claim 1, wherein the clients include master clients and target clients, wherein the arbiter is to alternate granting bus access to a requesting one of the master clients and a requesting one of the target clients.

3. The apparatus of claim 2, wherein the arbiter is to grant bus access to a requesting one of the target clients based on round-robin arbitration.

4. The apparatus of claim 2, wherein the arbiter is to grant bus access to a requesting one of the master clients based at least partly on hierarchical arbitration.

5. The apparatus of claim 1, wherein the arbiter comprises a programmable storage structure to store the programmable priority.

6. The apparatus of claim 1, wherein:
the age is indicated by a number of clock cycles since the ungranted bus request; and
the arbiter comprises logic to contain an indicator of the number of clock cycles.

7. The apparatus of claim 1, wherein:
the age is indicated by an elapsed time since the ungranted bus request; and
the arbiter comprises logic to contain an indicator of the elapsed time.

8. The apparatus of claim 1, wherein the bus is to use a split-transaction data transfer protocol.

9. The apparatus of claim 1, wherein the arbiter comprises a centralized arbiter.

10. A method, comprising:
determining which pending bus requests from clients have a highest programmable hierarchical priority and a greatest time interval since requesting access to a bus, based on an algorithm; and
granting access to the bus based on said determining.

11. The method of claim 10, further comprising limiting said determining to retried pending bus requests.

12. The method of claim 11, further comprising granting bus access based on existence of at least one special condition prior to granting bus access based on said determining.

13. The method of claim 10, wherein said determining further comprises determining priority based on order of physical connection among the clients, responsive to multiple clients having the highest programmable hierarchical priority and the greatest time interval since requesting access to the bus based on the algorithm.

14. The method of claim 10, wherein:
said determining is applied to the pending bus requests from master clients; and
bus requests from target clients are handled separately from said determining.

15. The method of claim 14, wherein the bus requests from the target clients are arbitrated using round robin priority.

16. A system, comprising:
a bus to transfer data between clients;
a volatile memory coupled to the bus; and
an arbiter coupled to the bus to arbitrate pending bus requests from a first type of the clients based on a programmable hierarchical ranking of the first type of the clients and on a time interval indicating how long each of the bus requests has been pending.

17. The system of claim 16, wherein the arbiter is to consider the time interval only when multiple ones of the pending bus requests have a same highest programmable hierarchical ranking.

18. The system of claim 17, wherein the arbiter is to give priority to retried bus requests before the pending bus requests based on the hierarchical ranking and the time interval.

19. The system of claim 16, wherein:
the first type of clients are master clients;
a second type of clients are target clients; and
the arbiter is to arbitrate bus requests from the target clients separately from arbitrating the bus requests from the master clients.

20. The system of claim 19, wherein the arbiter is to arbitrate bus requests from the target clients using round-robin priority.
